(19) United States
(12) Patent Application Publication
(10) Pub. No.: US 2015/0100384 A1
(43) Pub. Date: Apr. 9, 2015

(54) PERSONALIZED PRICING FOR OMNI-CHANNEL RETAILERS WITH APPLICATIONS TO MITIGATE SHOWROOMING

(71) Applicant: International Business Machines Corporation, Armonk, NY (US)

(72) Inventors: Markus R. Ettl, Ossining, NY (US); Pavithra Harsha, Yorktown Heights, NY (US); Shivaram Subramanian, Danbury, CT (US)

(73) Assignee: International Business Machines Corporation, Armonk, NY (US)

(21) Appl. No.: 14/289,123

(22) Filed: May 28, 2014

Related U.S. Application Data
(60) Provisional application No. 61/886,906, filed on Oct. 4, 2013.

(51) Int. Cl. G06Q 30/02

(52) U.S. Cl. CPC G06Q 30/0206
USPC 705/7.35

(57) ABSTRACT

Computing a personalized deal menu for a seller may be provided. The seller may operate one or more sales channels. A customer's willingness to wait in purchasing based on purchasing history of a customer may be determined. A purchase probability model that predicts a likelihood of the customer performing a purchase now compared to waiting to make the purchase may be formulated. A personalized price menu optimization model with one or more rules as constraints that jointly determines multiple prices, a price corresponding to a different purchase option with different lead time, may be solved. The personalized deal menu may be generated based on the solving.

### CROSS-REFERENCE TO RELATED APPLICATIONS

This application claims the benefit of U.S. Provisional Application No. 61/886,906, filed on Oct. 4, 2013, which is incorporated by reference herein in its entirety.

### FIELD

The present application relates generally to computers, and computer applications, and more particularly to computer-implemented analytics for retail personalized product pricing in an omni-channel environment, e.g., delivered on mobile phones.

### BACKGROUND

Traditional retailers are facing a number of challenges while finalizing their pricing strategy as they seek to transition from a brick-and-mortar sales model into a seamless multi-channel environment that now includes virtual channels like online, mobile, and social stores, while also having to manage their traditional call-center and catalog driven sales. On the other hand, the customer has evolved into mobile-enabled shopper with access to unprecedented pricing transparency, and is seeking a seamless omni-channel experience. The impact of mobile-enabled technology cannot be understated. In-store shoppers can scan product bar codes to obtain real-time access to the lowest prices offered at nearby stores and by e-tailers. The practice of a customer using a store as a showroom and subsequently completing the purchase elsewhere at the lowest or lower price on offer is called ‘showrooming’. Other customers may do ‘webrooming’, i.e., browse an assortment of products online and complete the purchase with another retailer in-store. Omni-channel, mobile technology, showrooming and webrooming influence contemporary retail industry.

### BRIEF SUMMARY

A method for computing a personalized deal menu, for example, for a seller that operates one or more sales channels, in one aspect, may comprise determining a customer's willingness to wait in purchasing, based on at least purchasing history of a customer. The method may also comprise formulating a purchase probability model that predicts a likelihood of the customer performing a purchase now compared to waiting to make the purchase. The purchase probability model may be formulated based on at least the customer's willingness to wait in purchasing. The method may further comprise solving a personalized price menu optimization model with one or more rules as constraints that jointly determines multiple prices, based on at least the purchase probability model. A price corresponds to a different purchase option with different lead time. The method may further comprise generating the personalized deal menu based on at least the solving.

A system for computing a personalized deal menu, for example, for a seller that operates one or more sales channels, in one aspect, may comprise one or more storage devices operable to store customer profile comprising purchasing history of a customer, product data and price data. A hardware processor may be operable to determine a customer's willingness to wait in purchasing, based on at least the purchasing history of a customer. The hardware processor may be further operable to formulate a purchase probability model that predicts a likelihood of the customer performing a purchase now compared to waiting to make the purchase. The purchase probability model may be formulated based on at least the customer's willingness to wait in purchasing. The hardware processor may be further operable to solve a personalized price menu optimization model with one or more rules as constraints that jointly determines multiple prices, a price corresponding to a different purchase option with different lead time, based on at least the purchase probability model. The hardware processor may be further operable to generate the personalized deal menu based on at least the solving.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating a method for computing prices in one embodiment of the present disclosure.

FIG. 2 shows a purchase probability modeling scenario in one embodiment of the present disclosure.

FIG. 3 shows a numerical example of quasi-hyperbolic discounting (QHD) customer as compared to a price-sensitive strategic (PSS) customer.

FIG. 4 shows example computational performance in executing a methodology of the present disclosure in one embodiment.

FIG. 5 illustrates a schematic of an example computer or processing system that may implement a personalized pricing system in one embodiment of the present disclosure.

### DETAILED DESCRIPTION

A methodology of the present disclosure in one aspect prescribes advanced analytical price recommendations that combine all concepts of omni-channel, mobile technology, and showrooming in a systematic manner. The methodology may transform the mobile technology into an asset for the retailer in mitigating showrooming, by providing an in-store shopper with a real-time optimized price deal menu. In one embodiment, the methodology may overcome the deficiency of the traditional pricing approaches that are based on a customer segmentation based on willingness-to-pay, and product-centric and service-centric lead-time elasticity, and that fail to systematically understand the intrinsic personalized need of individual customers. The methodology in one embodiment may systematically address the tradeoffs made by a customer who balances his/her willingness-to-pay with his/her ‘willingness-to-wait’, which the current personalized pricing approaches do not address. The methodology of the present disclosure may bridge these gaps and achieve this tradeoff in a profitable manner.

A personalized pricing approach may be presented to effectively deal with certain practical pricing problems that arise in an omni-channel environment. The methodology of the present disclosure can be applied to manage the phenomenon of showrooming, where an in-store customer browses a product but places an order with an online retailer (same or different) based on their personal willingness-to-wait for the product and willingness-to-pay the price offered. Although the present disclosure refers to showrooming, the methodology of the present disclosure may be also applicable to a variety of situations where profitable time-dependent deal-menus, based on a person's willingness-to-wait have to be delivered to a shopper in real time, for example, to manage ‘webrooming’ where shoppers browse one or more product online but go to another retailer's store nearby to make the final purchase.

The methodology in on embodiment develops a nested-attraction based time-dependent win-probability model to predict the chances of a particular customer buying the browsed product in-store, or order online and wait for the product, and embed this with an optimization module to prescribe a personalized instant deal menu that has a time-dependent and time-consistent vector of prices that maximizes the expected profitability, while also satisfying a lower threshold for win-probability.

In another aspect, the methodology of the present disclosure also considers product substitution where a customer, with a certain probability, may also choose to purchase an alternative product in the same or different channel The methodology may calibrate a customer's willingness-to-wait using their omni-channel purchase history, and continually refine this measurement by learning their response to past deal menu offers. This estimation procedure allows the methodology to differentiate between quasi-hyperbolic discounting, and the price-sensitive strategic customer segments, and tailor the price offering suitably. The methodology of the present disclosure in one embodiment transforms the nonlinear nested-attraction optimization model into a mixed-integer program in the presence of win probability constraints. The methodology may include developing a sequence of transformations that allows one to recover the optimal pricing trajectory for single-product instances in real-time (sub-second run times on mobile devices).

For the multi-product problem, the methodology of the present disclosure may include two approaches. The first is a column generation based iterative decomposition approach that solves a one-product model at each iteration. This approach may be particularly useful when products are sold as a bundle, or include complementary products. The second method employs a piecewise linear approximation of the attractiveness of a time-nest to recover a mixed integer programming (MIP) formulation when the products are substitutes. Computational results are presented using simulated data. The results indicate that the proposed personalized price optimization methodology can be effectively deployed within practical retail revenue and price management applications.

In one aspect, the personalized willingness-to-wait approach of the present disclosure recognizes time-inconsistent discounting, e.g., disproportionate preference for deriving immediate benefits (buy now), preference for postponing costs (order now, skip long lines), Laibson's Quasi Hyperbolic Discounting model (discrete time), and calibrated using multiple omni-channel data sources. This approach manages omni-channel fulfillment complexity, e.g., customers can order-in store, pay now, or ship to store or home, order at-home and ship to home or store, multiple shipping options, purchases choices corresponding to the same waiting-time can be nested.

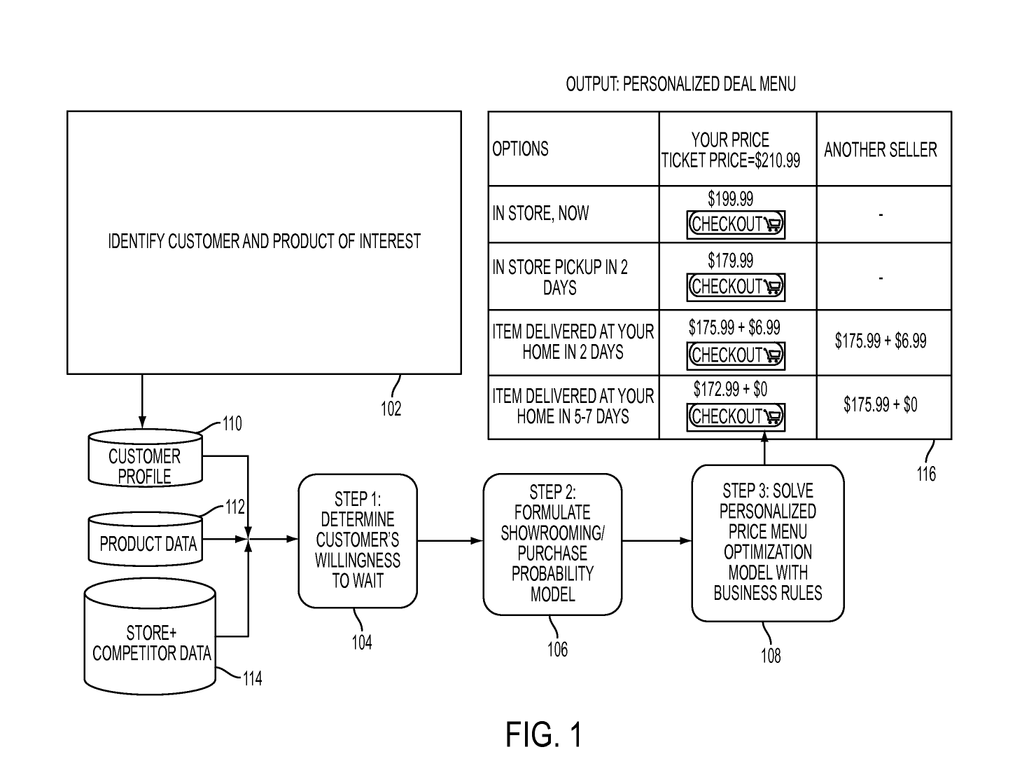

FIG. 1 is a diagram illustrating a method for computing prices in one embodiment of the present disclosure. The method may compute a personalized deal menu for a seller that operates one or more sales channels. At 102, a customer and a product of interest are identified. For example, consider a mobile-enabled shopper walking into a store with intention to purchase a specific product. The shopper can choose to buy the product in-store, or order in-store and pick up the product later at home or in-store if they are willing to wait, or walk to another store and repeat this process, or decide to simply not buy the product. The shopper may identify or specify the product of interest, e.g., by scanning a product code or otherwise specifying the product identification. In another aspect, the customer and the product of interest may be identified from previously stored information for performing the methodology of the present disclosure.

At 104, a customer's willingness to wait is determined. This determination may use the customer's purchasing history, e.g., retrieved from a customer profile 110. In one aspect, the customer's willingness to wait may be computed using the following data: Customer's (or at least customer segment's) prior omni-channel purchase history, e.g., purchase history through different channels of sales such as brick and mortar, online web site, mobile app, and/or others; The win-loss history for prior deal menus offered for the product, by customer segment; Product sales historical time-series data. The customer's willingness to wait in one embodiment may be computed, for example, by employing the following two-step procedure for a given value of correlation coefficient μ(t)=μ:
a) In the first step, we calibrate the lower-level, intra-nest coefficients associated with each product choice within a nest. One embodiment uses the known multinomial logit (MNL) or a generalized attraction model using historical product sales data (by channel), where the historical market-shares of each product-choice are jointly regressed against the predicted relative attractiveness of that choice by maximizing the log-likelihood estimate (MLE) of the data fitting the postulated MNL model. The coefficients estimated in this step may include the product and channel attractiveness coefficients (ν), as well as the price sensitivity within each nest (β). After this step, the historical estimates of inclusive value Iₜ for each nest can be computed. Note that the data used in the lower-level is product and store (channel) channel data that can be anonymous and aggregate and not necessarily tied to specific customers or customer-segments.
b) In the second step, we calibrate the upper-level (inter-nest) choice model, again as an MNL or attraction model. The coefficient to be estimated here is the willingness-to-wait coefficient λ for each nest (from which the lead-time elasticity (LTE) of the customer can be imputed, e.g., for the purposes of display). Again, the MLE routine of step (a) can be employed, by regressing the historical market-share for each time-nest against the relative attractiveness of the nest using the purchasing history of the customer or customer-segment to identify the time-nests chosen in history. These two steps (a)-(b) are repeated for different values of μ (e.g. 0, 0.1, 0.2, . . . , 1.0), and we select that value of p that yields the best model fit (e.g., defined in terms of mean absolute percentage error (MAPE) between actual and predicted market-shares of product choices in historical data).
c) Additionally, if prior history is available that also records whether the customer did not complete the purchase (“loss”) rather than only record “wins” (customer placed an order), then this additional loss-history can be gainfully employed to further improve the prediction accuracy of the higher-level model by incorporating an additional ‘no buy’ nest in the upper-level. Note that Nested-Logit model calibration can also be performed using alternative prior-art methods published in econometrics textbooks.

In one embodiment, e.g., as described above with (a)-(b) and optional (c) procedures, a methodology of the present disclosure may employ the following estimation procedure to enable near-instantaneous calculations: i) Estimate the intra-nest utility function coefficients (including price elasticity) for the products within each time-nest using a maximum-likelihood estimation (MLE) method for multinomial logit (MNL); ii) Use this to compute the inclusive value I for each nest in each historical observation; iii) Estimate the nest-level utility coefficients (including personalized wait-time elasticity) re-using the MLE method for MNL of step (i). The MLE approach for the MNL parameter calibration is a global concave optimization problem that can be solved efficiently using a standard methods, on-demand, and in real-time. Note that the lower-level model coefficients can be common across customers and pre-calculated. For a given customer looking to finalize a purchase, only the higher-level model and their willingness-to-wait coefficient needs to be estimated using their purchase history. Toward this, the MLE algorithm using the Newton-Raphson method using regularization penalties (prior art) is fast enough to be executed in real-time, on-demand and triggered by a customer scanning a bar-code using a mobile device using a specific app, or requesting a price-match.

At 106, a purchase probability model is formulated. The purchase probability model may provide a probability distribution that shows or predicts a likelihood of the customer performing a purchase now compared to waiting to make the purchase. For example, the purchase probability model may predict the probability that an in-store customer having a calculated willingness-to-wait profile will purchase the product in-store at a given store price with zero wait time, or online (at the specified online price plus shipping and handling) after waiting one or more days. The purchase probability model is described further below.

At 108, a personalized price menu optimization model, e.g., with one or more rules as constraints, may be solved. This model may be formulated based on product data 112, competitor data and attributes 114, and the customer's willingness to wait determined at 104. The personalized price menu optimization model jointly solves for, or determines multiple prices, one price of the multiple prices corresponding to a different purchase option with different lead time. In one aspect, the personalized price menu optimization may include a joint personalized price-time trajectory optimization for a single product (this can be via continuous or discrete prices) that uses the nested attraction model to determine the optimal prices over a plurality of waiting-time nests (including zero wait). In another aspect, the personalized price menu optimization may include joint personalized price optimization for a plurality of substitutable or complementary products, e.g., determine the joint optimal prices of multiple products over multiple wait time nests. An iterative scheme may be used that alternates between solving a master (inter-nest) program and many intra-nest subproblems. The personalized price menu optimization model may be a nest attraction model that solves for optimal prices while satisfying a plurality of constraints, e.g., including price consistency, win-probability and minimum expected revenue.

The solutions from the personalized price menu optimization model are used to generate the personalized deal menu.

An example of the generated personalize deal menu is shown at 116. The personalized price menu specifies a product, and the multiple prices associated with the product and lead times (e.g., time from purchase to delivery) respectively associated with the multiple prices. For example, a price for different options may be presented such as a price for purchasing in store now, a price for in store pickup in 2 days, a price for the item if it were to be delivered to the customer's location in 2 days, and a price for the item if it were to be delivered to the customer's location in 5-7 days. Other options may be provided. In addition, one or more competitor's prices for the same options may be presented.

In one aspect, the prices may be provided for different sales channels also, for example, buying via brick and mortar store, buying via one or more online stores (e.g., mobile app, web site, social site). The personalized deal menu is generated responsive to the customer inputting a product, and may be sent to the customer over one or more of a mobile device, a web site page, or by other electronic means. In another aspect, the personalized deal menu may be generated for a seller for a product that the seller is selling.

As described above, a prediction-optimization method may be presented for retailers that performs a personalized deal menu generation in real-time in an omni-channel environment. In one embodiment, the method estimates and incorporates an individual's personalized willingness-to-wait within a nested attraction based win probability model.

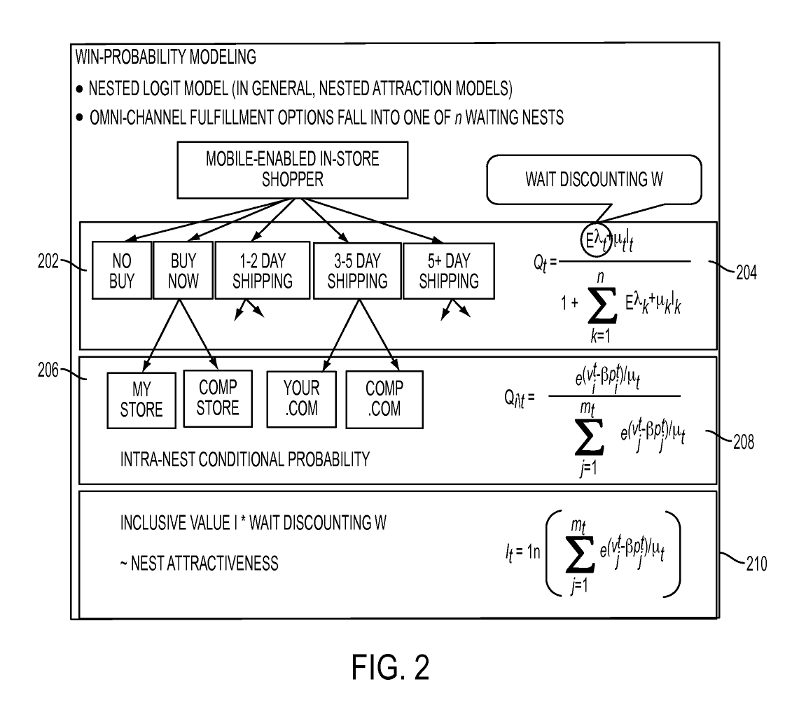

The following provides more details of a win probability model, also referred to as a purchase probability model shown at 106. As described above, consider a mobile-enabled shopper walking into a store with intention to purchase a specific product. The shopper can choose to buy the product in-store, or order in-store and pick up the product later at home or in-store if he/she is willing to wait, or walk to another store and repeat this process, or decide to simply not buy the product. This situation can be represented using the equations shown in FIG. 2. The figure shows a plurality of nests (wait time), e.g., no buy, buy now, 1-2 day shipping, 3-5 day shipping, and 5+ day shipping, e.g., shown at 202. For a simplest case, there may be three nests: no-buy, buy now or buy later; This case may be the easiest prediction model to calibrate in practice. Any other number of nests may be modeled. In one aspect, if personalized willingness-to-wait cannot be calculated (e.g., due to unavailability of individual shopping history), then customers can be segmented into different willingness-to-wait clusters using other customer attribute data such as their relative propensity to buy online versus in-store, or another information.

The model (equation) shown at 204 represents a probability that a customer will purchase product i from lead-time availability nest t. The model (equation) shown at 208 represents a conditional probability that the customer will select product i among alternatives in the same time-to-availability nest t. For example, within the same nest of “buy now”, a customer may choose from a seller's store or another seller's store. A purchase probability model may be computed as a product of the model (equation) shown at 204 and 208. The notations of those equations are described below.

An optimization model (e.g., shown at 108 in FIG. 1) balances a customer's estimated willingness-to-wait and their willingness-to-pay to prescribe a time-dependent vector of prices for the product of interest. This method may be suitable for retailers to combat showrooming/webrooming and mitigate its effects, and convert potential showroomers into shoppers. In the present disclosure, the nonconvexity of the optimization formulation is recognized and algorithms are presented to recover a transformed formulation that can be used to generate quick solutions. Computational analysis on many random instances reveal sub-second central processing unit (CPU) times on average, which provides empirical evidence of its viability in real-time applications. The present disclosure also prescribes an iterative decomposition method and a piecewise linear approximation to solve the multi-product case.

The following presents formulating an optimization model for both a single product and multi-product cases.

### Profitability Optimization Model for a Single Product

This model represents a personalized deal menu optimization model for a single product case in one embodiment of the present disclosure. Prior optimal pricing methods for the MNL demand models transform the problem from price space into market-share space and recover concavity (or uni-modality) of objective. The benefit of the transformation (i.e., convexity of the optimization problem) is preserved as long as the pricing constraints are restricted to two price variables that have +1 and −1 coefficients, respectively, and have the same price sensitivity coefficients. Other simple pricing constraints translate to non-convex constraints in the market-share space yielding the transformation into a futile exercise. A known methodology solve the general, practical MNL instances using discretized pricing for industrial applications. Prior approaches for the NL demand models analyzed unconstrained problems only. However, because NL generalized the MNL demand models, all the concerns raised above hold also for the NL demand model.

A methodology of the present disclosure in one embodiment solves a price optimization problem with a NL demand model with general pricing constraints and discretized prices. Transformations are presented in the present disclosure that allows a practical personalized price-deal menu optimization with win-probability constraints to be solved efficiently. However, the introduction of time-consistent pricing rules may destroy structure. Toward this, a methodology of the present disclosure in one embodiment proposes an efficient MIP (mixed-integer program) based approach for NL and general nested attraction models that can be solved in sub-second run times. A methodology of the present disclosure in one embodiment employs the RLT (Reformulation-Linearization Technique) to transform the problem into an MIP. The general MIP formulation is shown in Equation (5) below.

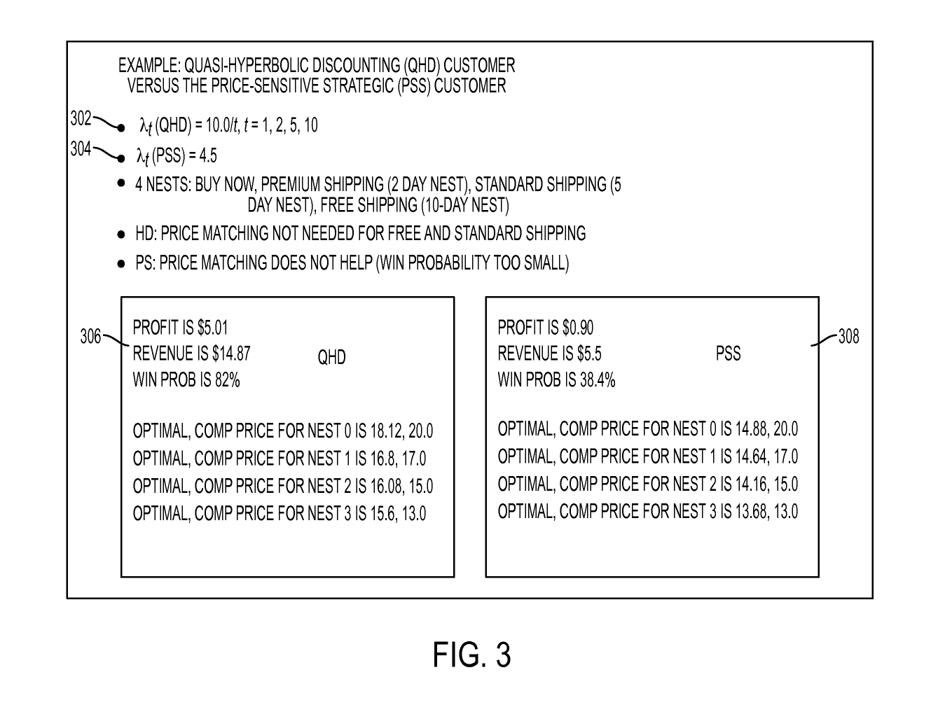

FIG. 3 shows a numerical example of quasi-hyperbolic discounting (QHD) customer as compared to a price-sensitive strategic (PSS) customer. Quasi-hyperbolic discounting (QHD) customer is a customer that is not willing to wait, i.e., and has a relatively larger λ value for today's nest and disproportionately smaller values for future time nests. A price-sensitive strategic (PSS) customer is willing to wait for a lower price, and has relatively the same 2. across nests. 302 shows QHD customer's willingness to wait, which is inversely proportional to time t. 304 shows PSS customer's willingness to wait, which stays flat (e.g., value 4.5). For a single product, there may be 4 nests, e.g., buy now, premium shipping (2 day nest), standard shipping (5 day nest), free shipping (10 day nest). For QHD, price matching may not be needed for free and standard shipping, e.g., because the QHD customer is disproportionately more sensitive to lead time of availability, and therefore the attractiveness (including price) of the product on offer today or available via premium shipping is most relevant to this shopper. For PSS, price matching might not help because the win probability may be too small. 306 shows computed personalized deal menu with prices for different nests (e.g., purchase options with different lead time) for a QHD customer. 308 shows computed personalized deal menu with prices for different nests (e.g., purchase options with different lead time) for a PSS customer. This output is shown for the single product case. In the case of multiple products, the output displays the prices of the bundle (if complementary items), or the individual products (if substitutes), along with different lead times, in a similar manner.

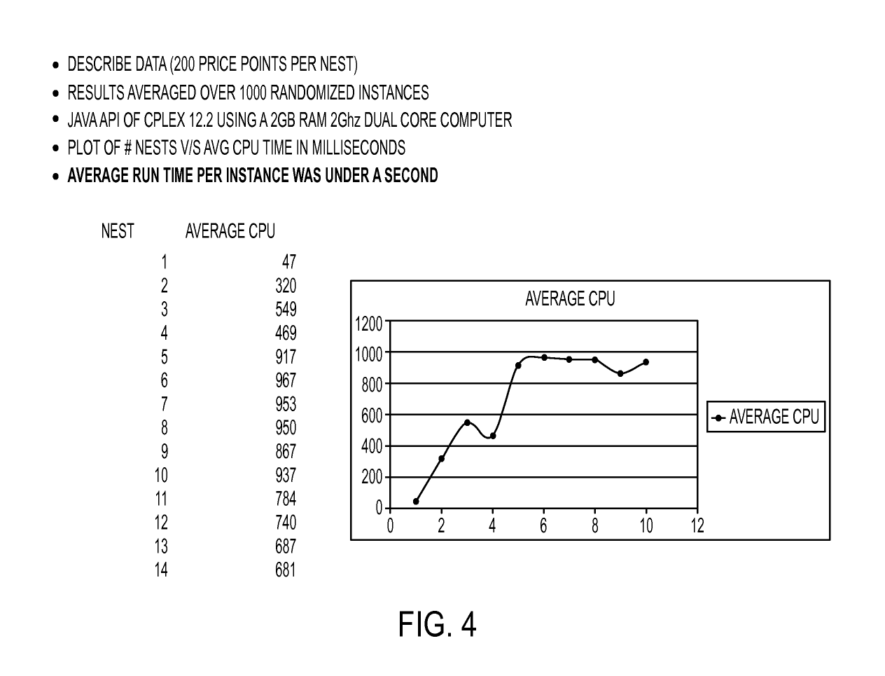

FIG. 4 illustrates example computational performance in executing a methodology of the present disclosure in one embodiment. The information shown in FIG. 4 is for a single-product, shows statistics averaged over many numerical instances of data generated using a variety of different coefficient values, representing a variety of customer types that range between QHD and PSS. The plot 402 shows average central processing unit (CPU) run time computation for a number of nests. X-axis represents average CP time in milliseconds. Y-axis represents a number of nest. Average run time per instance is shown to be under a second. An instance refers to one numerical instance with fully calibrated win-probability and optimization model for a single product.

### Profitability Optimization Model for Multiple Products

In considering multiple products, there may be two possible product group types: 1) Products include complementary items or are grouped as a bundle; 2) Products are substitutes. For the general case where products can be of either type, a methodology of the present disclosure in one embodiment proposes the following column generation approach that iteratively solves:
a) A subproblem for each nest to generate a vector of prices from each nest (as well as the corresponding conditional profitability and conditional win probability metrics), which is passed on to the master program.
b) The master program solves a linear program to generate a new vector of lagrangrian multiplier values for each nest.
c) Iterate between steps (a) and (b) until the lagrangian multipliers converge or a maximum iteration limit is reached.
d) Solve the integer program that jointly optimizes the best price vectors from nest that maximizes overall profitability, while satisfying all constraints.
e) During (d), additional prices from nests can generated using the prior art technique of branch-and-price.

The multiple products are typically a substitutable set of items. Known methods can be employed to solve the subproblem.

### Formulating the General Multi-Product Case

In the single-item case, all except one item's price-trajectory is assumed to be fixed at prior, known values. In the general, multi-item case, it is assumed in one embodiment of the methodology of the present disclosure, that a customer, who selects an item, may potentially end up purchasing an alternative product from a set of substitutable options located in the same shopping aisle, and therefore a personalized discount can be offered for the entire group of substitutes. In the multiproduct case, a deal menu output of the present disclosure in one embodiment displays the optimized deals offered for not just the customer-scanned product (or received product identification), but also the deals for the nearest substitutes in the assortment that is sold by the retailer (e.g., located in the same aisle). In another scenario, the customer may want to purchase a plurality of products that may be complementary in nature.

In the analytics of the present disclosure, there may be additional inter-product constraints that require the same discount trajectory for all these substitutes, or each of them may have their own price trajectory over time. In the former case, a methodology of the present disclosure in one embodiment may assume that the group of products can be treated as an aggregated single-item and priced using the method described for the single item. In the latter case, a more sophisticated method can be employed, as described below.

The following notations are used in the below equations:
pₜⁱ price of product i having time-to-availability t (decision variables);
qᵢ|t=conditional probability that the customer will select product i among alternatives in the same time-to-availability nest t;
Qᵢₜ=probability that a customer will purchase product i from lead-time availability nest t;
Qₜ=probability that a customer will purchase a product from lead-time availability nest t
cᵢ=unit cost of product i;
c=generally, unit cost of product;
νᵢₜ=customer value coefficient for item i including the specific retail-channel experience;
βᵢ=price sensitivity coefficient for product i;
λₜ=lead-time elasticity coefficient for the customer;
μₜ=inter-nest similarity coefficient;
dₜ=channel-weight in nest t;
L=price ladder, (l, u)=price bounds, having J price-points in the ladder;
n=number of time-to-availability nests;
mₜ=number of choices in nest t;
wₘᵢₙ=user-specified minimum win-probability threshold.

$${q}_{i \vert t} = \frac{{e}^{( {v}_{i}^{t} - {β}_{i} {p}_{i}^{t} ) / {μ}_{t}}}{{\sum }_{j = 1}^{{m}_{t}} {e}^{( {v}_{j}^{t} - {β}_{i} {p}_{j}^{t} ) / {μ}_{t}}} \\ {Q}_{t} = \frac{{e}^{{λ}_{t} + {μ}_{t} {I}_{t}}}{1 + {\sum }_{k = 1}^{n} {e}^{{λ}_{k} + {μ}_{k} {I}_{k}}} \\ {I}_{t} = ln ( {\sum }_{j = 1}^{{m}_{t}} {e}^{( {v}_{j}^{t} - {β}_{j} {p}_{j}^{t} ) / {μ}_{t}} ) \qquad ( 1 )$$

### Nonlinear Pricing Formulation

$$MPDM \text{:} Maximize {\sum }_{t = 1}^{n} {\sum }_{i = 1}^{{m}_{t}} {d}_{t} ( {p}_{t}^{i} - {c}_{t}^{i} ) {Q}_{t} {q}_{i \vert t} \\ subject to \text{:} \\ {p}_{t}^{i} \geq {p}_{t + 1}^{i} ∀ i , \\ t = 1 , … , n - 1 \\ {\overline{a}}_{{i}_{r}} {p}_{t}^{i} \leq {\overline{b}}_{{j}_{r}} {p}_{t}^{j} + {\overline{e}}_{r} , \\ ∀ r = 1 , … , K - 1 , \\ t = 1 , … , n - 1 \\ {\sum }_{t = 1}^{n} {\sum }_{i = 1}^{{m}_{t}} {Q}_{t} {q}_{i \vert t} \geq {w}_{min} \\ p ∈ L , \\ l \leq p \leq u \qquad ( 2 )$$

The above maximization formulation (Eq. 2) jointly determines the decision variable pₜⁱ across all nests, and represents an optimization model that maximizes expected profitability across all nests, across all channels and across time. The first shown constraint refers to non-increasing price over time; the second shown constraint refers to brand price constraints, which may be applicable to multi-product case; the third shown constraint refers to the total probability of making a sale as a minimum threshold; the fourth shown constraint refers to price ladder, e.g., discount. Those are example constraints applied in solving a personalized deal menu optimization model in one embodiment of the present disclosure. In the above equations, j represents the price ladder index, i represents the product choice index, t represents the time-nest index.

For the general showrooming/webrooming case, there is a group of products to be priced in each nest. The price of each item is non-increasing over time (e.g., specified in the first constraint), and prices within a time-nest are subject to a plurality of inter-item pricing constraints that may represent brand-price relationships, unit-measure rules, and other requirements, e.g., store brand cheaper than national brand, per-ounce prices must be the same, and others (e.g., shown in the second constraint). A methodology of the present disclosure in one embodiment may apply a price-ladder (e.g., shown in the fourth constraint) that allows to specify the prediction model at each of the price points. However, unlike the single-item case, the win-probability of the item at a price point may not be pre-calculated, since the relative attractiveness of substitutes needs to be accounted for, which are themselves variable and dependent on their discounts.

A methodology of the present disclosure in one embodiment defines binary price ladder variables zⱼₜⁱ, j=1, . . . , J which is positive when the j^{th} bound-feasible price point for product i ( p̅ⱼₜⁱ) for nest t is active in the optimal solution, and zero, otherwise. This allows to equivalently represent the prediction model equations as follows:

$${d}_{t} ( {p}_{t}^{i} - {c}_{t}^{i} ) {q}_{i \vert t} = \frac{{\sum }_{j = 1}^{J} {\overline{g}}_{jt}^{i} {z}_{jt}^{i}}{{\sum }_{k = 1}^{{m}_{t}} {\sum }_{j = 1}^{J} {\overline{v}}_{jt}^{k} {z}_{jt}^{k}} \\ {I}_{t}^{′} = {e}^{{I}_{t}} = ( {\sum }_{k = 1}^{{m}_{t}} {\sum }_{j = 1}^{J} {\overline{v}}_{jt}^{k} {z}_{jt}^{k} ) \\ {Q}_{t} = \frac{{e}^{{λ}_{t}} {I}_{t}^{′ {μ}_{t}}}{1 + {\sum }_{k = 1}^{n} {e}^{{λ}_{t}} {I}_{t}^{′ {μ}_{t}}} \\ {d}_{t} ( {p}_{t}^{i} - {c}_{t}^{i} ) {q}_{i \vert t} {Q}_{t} = \frac{{\sum }_{j = 1}^{J} {\overline{g}}_{jt}^{i} {z}_{jt}^{i}}{1 + {\sum }_{k = 1}^{n} {e}^{{λ}_{t}} {I}_{t}^{′ {μ}_{t}}} {e}^{{λ}_{t}} {I}_{t}^{′ {μ}_{t}} \qquad ( 3 )$$

### Formulation—1: Using Single-Item Model Approximation

Unlike the single item case, the values for I and Q may not be able to be pre-calculated as mentioned earlier. However, given an inter-product constraint and bound feasible price vector <p>ⱼₜ, j=1, . . . , for the demand group in a nest, a methodology of the present disclosure in one embodiment can calculate the resulting values of q, Q, and I. This allows to pose Problem MPDM in an equivalent discrete linear-fractional form similar to the single-product case, which in turn allows to recover a linear reformulation by applying the transformation shown below after defining:

$$y = \frac{1}{1 + {\sum }_{k = 1}^{n} {e}^{{λ}_{k} + {μ}_{k} {I}_{k}}} , \\ {x}_{tj} = {yz}_{tj} ∀ ( j , t ) \qquad ( 4 )$$

A win-probability constraint is added below using w-variables, and by specifying a lower bound on the expected purchase probability wₘᵢₙ, where the w̅ values in the final formulation below are pre-calculated. Additional RLT-type valid inequalities can be optionally added toward improving the representation of the underlying continuous relaxation even though they are redundant in the discrete sense. The resultant formulation (MPDMIP: Multi-product Deal-Menu Mixed-Integer Program) is shown below. As mentioned earlier, this formulation can be used to solve the single-item case as well.

$$MPDMIP \text{:} Maximize {\sum }_{t = 1}^{n} {\sum }_{j = 1}^{J} {g}_{tj} {x}_{tj} \\ subject to \text{:} \\ {\sum }_{t = 1}^{n} {\sum }_{j = 1}^{J} {\overline{v}}_{tj} {x}_{tj} + y = 1 \\ {\sum }_{j = 1}^{J} {x}_{tj} = y ∀ t = 1 , … , n - 1 \\ {\sum }_{j = 1}^{J} {z}_{tj} = 1 ∀ t = 1 , … , n - 1 \\ {x}_{tj} \leq {z}_{ij} ∀ ( t , j ) \\ {x}_{tj} \geq y + {z}_{ij} - 1 ∀ ( t , j ) \\ {\sum }_{j = 1}^{J} {\overline{p}}_{tj}^{i} {z}_{tj} \geq {\sum }_{j = 1}^{J} {\overline{p}}_{t + 1 , j}^{i} {z}_{t + 1 , j} ∀ i , \\ t = 1 , … , n - 1 \\ {\sum }_{t = 1}^{n} {\sum }_{j = 1}^{J} {w}_{tj} {x}_{tj} \geq {w}_{min} \\ 0 \leq y \leq 1 , \\ 0 \leq x \leq 1 , \\ z binary . \qquad ( 5 )$$

Eq. (5) above shows a linearized and transformed formulation of Eq. (2) above, that represents in one embodiment a personalized deal menu optimization model for a single-product case. The formulation of Eq. (5) maximizes total expected profit over all time nests arising from product viewed by the customer. The first constraint in Eq. (5) ensures that the total sum of the probability of purchase and non-purchase equals 1.0. The next four constraints are inequalities arising from the application of the reformulation-linearization technique (RLT) that ensure that when the price of the product in a nest is chosen from exactly one of the values from its price ladder, the correct value of the resulting purchase probability and profit value is selected in the output. The sixth and seventh constraints ensure price monotonicity, and a minimum level of purchase probability, respectively. The last constraint imposes binary restrictions and bound restrictions on the various variables used, as appropriate.

Unlike the single-product case, where the number of price possibilities (J) was linear in the size of the price-ladder, there are an exponential number of price-vector combinations for the demand group, and in practice, a methodology of the present disclosure in one embodiment may dynamically and iteratively enumerate a small subset of the J possibilities to improve solution quality and performance. There are prior-art methods to accomplish this task. In particular, a methodology of the present disclosure in one embodiment may adopt a column generation heuristic that produces a new and improved price vector for each nest at every iteration by solving either exactly, or heuristically, a nest-level subproblem that represents a MNL profit optimization formulation. This subproblem aims to maximize a reduced profit objective which consists of the original profit less then dual costs associated with pricing constraints, which are obtained by solving the linear programming relaxation of MPDMIP. The resultant subproblem resembles the regular price optimization problem studied in the literature and can be solved either approximately or exactly. This approach is useful when the products are sold as a bundle, or have items that are complementary in nature (e.g., core product and accessories).

### Formulation—2: (Substitutable Products) MIP Formulation Using Piecewise Linear Approximation of Inclusive Value

The multi-product problem when all products are substitutable can be solved more compactly as a single model using an MIP approach based on a piecewise linear approximation of the Inclusive value I^{I} using Special-ordered sets of type-2 (SOS-2) variables ‘s’. (SOS-2 represents a condition on a sequence of variables such that no more than two of the variables are nonzero and the nonzero variables are adjacent in the sequence).

$${d}_{t} ( {p}_{t}^{i} - {c}_{t}^{i} ) {q}_{i \vert t} {Q}_{t} = \frac{{\sum }_{j = 1}^{J} {\overline{g}}_{jt}^{i} {z}_{jt}^{i}}{1 + {\sum }_{k = 1}^{n} {e}^{{λ}_{t}} {I}_{t}^{′ {μ}_{t}}} {e}^{{λ}_{t}} {I}_{t}^{′ ( {μ}_{t} - 1 )} \\ {y}_{t} = \frac{{e}^{{λ}_{t}} {I}_{t}^{′ ( {μ}_{t} - 1 )}}{1 + {\sum }_{k = 1}^{n} {e}^{{λ}_{t}} {I}_{t}^{′ {μ}_{t}}} = \frac{{\sum }_{j = 1}^{L} {\overline{l}}_{jt} {s}_{jt}}{1 + {\sum }_{k = 1}^{n} {\sum }_{j = 1}^{L} {\overline{h}}_{jk} {s}_{jk}} \\ {f}_{jt} ≡ {y}_{t} {s}_{jt} , \\ {x}_{jt}^{i} ≡ {y}_{t} {z}_{jt}^{i} \qquad ( 6 )$$

These novel transformations enable us to solve the substitutable multiproduct case efficiently as an MIP using any effective commercial MIP optimization solver (e.g., International Business Machines Corporation, Armonk, N.Y. (IBM) CPLEX) that can manage SOS-2 variables efficiently. The resultant model PWMIP (Piecewise Mixed-Integer Program) is shown below.

$$PWMIP \text{:} Maximize {\sum }_{t = 1}^{n} {\sum }_{j = 1}^{J} {\sum }_{i = 1}^{{m}_{t}} {\overline{g}}_{jt}^{i} {x}_{jt}^{i} \\ subject to \text{:} \\ {\sum }_{j = 1}^{J} {x}_{jt}^{i} = {y}_{t} ∀ t = 1 , … , n - 1 , ∀ ( i , t ) \\ {\sum }_{j = 1}^{J} {z}_{jt}^{i} = 1 ∀ t = 1 , … , n - 1 , ∀ ( i , t ) \\ {x}_{jt}^{i} \leq {z}_{jt}^{i} ∀ ( i , t , j ) \\ {x}_{jt}^{i} \geq {y}_{t} + {z}_{jt}^{i} - 1 ∀ ( i , t , j ) \\ {\sum }_{k = 1}^{n} {\sum }_{j = 1}^{L} {\overline{h}}_{jk} {f}_{jk} + {y}_{t} = {\sum }_{j = 1}^{L} {\overline{l}}_{jt} {s}_{jt} , ∀ t \\ {\sum }_{j = 1}^{L} {f}_{jt} = {y}_{t} ∀ ( i , t ) \\ {\sum }_{j = 1}^{L} {s}_{jt} = 1 ∀ t = 1 , … , n - 1 \\ {f}_{jt} \leq {s}_{jt} ∀ ( t , j ) \\ {f}_{jt} \geq {y}_{t} + {s}_{jt} - 1 ∀ ( t , j ) \\ {\sum }_{j = 1}^{J} {\overline{p}}_{tj}^{i} {z}_{tj} \geq {\sum }_{j = 1}^{J} {\overline{p}}_{t + 1 , j}^{i} {z}_{t + 1 , j} ∀ i , \\ t = 1 , … , n - 1 \\ {\overline{a}}_{{i}_{r}} {\sum }_{j = 1}^{J} {\overline{p}}_{tj}^{i} {z}_{jt}^{i} \leq {\overline{b}}_{{l}_{r}} {\sum }_{j = 1}^{J} {\overline{p}}_{tj}^{i} {z}_{zt}^{i} + {\overline{e}}_{r} , \\ ∀ r = 1 , … , K - 1 , ∀ t \\ {\sum }_{t = 1}^{n} {\sum }_{j = 1}^{J} {\overline{w}}_{tj} {x}_{tj} \geq {w}_{min} \\ 0 \leq y \leq 1 , \\ 0 \leq x \leq 1 , \\ z binary , \\ s SOS \text{-} 2. \qquad ( 7 )$$

Eq. (7) above shows a linearized and transformed formulation of Eq. (2) above, that represents in one embodiment a personalized deal menu optimization model for a multi-product case. The objective of Eq. (7) is to maximize total expected profit over all substitute products and time nests that are offered for sale by the retailer, which is of interest to the customer. The first nine constraints in Eq. (7) are inequalities arising from the application of the reformulation-linearization technique (RLT) that ensure that the aforementioned transformations are computed correctly. The next three constraints ensure price monotonicity, inter-item pricing rules, and a minimum level of purchase probability, respectively. The last constraint imposes binary restrictions, bound restrictions, and special-ordered set (type-2) requirements on the various variables used, as appropriate.

A methodology of the present disclosure in one embodiment may provide a customer centric view. This approach produces a personalized price menu for a customer, for example. A Challenge arises in estimating the lead-time elasticity (LTE) of purchase of any product which a customer has never purchased before. Consequently analytics derived from the sales history for that product (derived from other customers) is of limited use for selling to a current customer. A methodology of the present disclosure in one embodiment may overcome this gap by additionally looking at customer's omni-channel purchase profile to learn the customer's intrinsic channel preference and willingness to wait and combine this with a products utility.

A methodology of the present disclosure in one embodiment may take an integrated view to pricing in the omnichannel environment (e.g., as opposed to optimizing each channel separately).

In embodiment, bi-level nested logit approach may be used. In another embodiment, bi-level attraction model may be used.

As an example scenario, when a potential showroomer comes to a retailer, a methodology of the present disclosure in one embodiment determines a customer's willingness to wait (e.g., as opposed to a product-centric LTE). The methodology may integrate and jointly model, and optimize across channels utilizing a customer's omni-channel purchase preferences.

Challenge posed with a single level logit model (because it violates the IIA (independence of irrelevant alternatives) property that holds for multinomial logit models, may be overcome in the methodology of the present disclosure by applying a bi-level choice model that dynamically clusters similar or correlated items into one nest.

In one aspect, customer-centric lead time elasticity (LTE), e.g., willingness-to-wait and pay may be derived from customer's omnichannel purchase history. Purchase probability computation in one aspect may provide for joint estimation of probability of purchase of any item across channels for a given customer, e.g., with dynamic clustering (nests) of purchase options with similar customer willingness-to-wait, across channels. In providing omnichannel pricing, a real-time personalize deal menu may be generated and provided, e.g., based on integrated pricing across all channels, and taking into account the tradeoff between retailer-margin and customer-value within and across personalized LTE clusters.

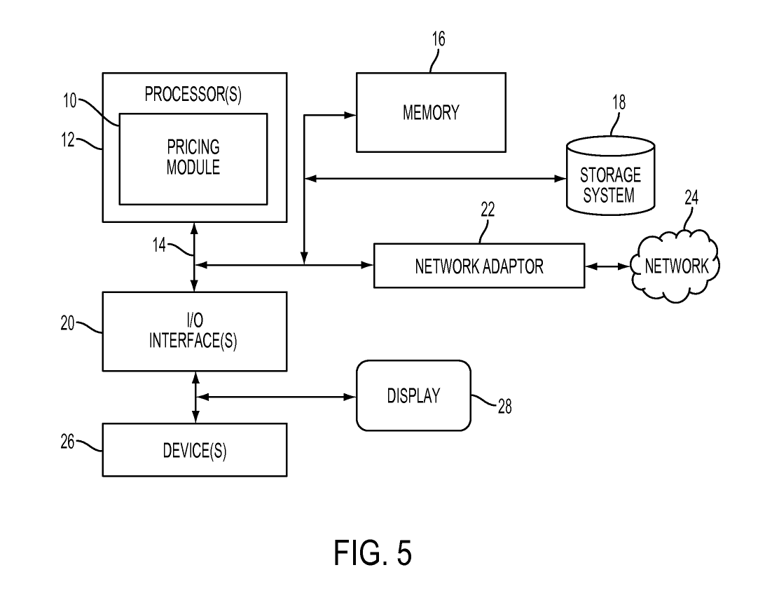

FIG. 5 illustrates a schematic of an example computer or processing system that may implement a personalized pricing system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for computing a personalized deal menu for a seller that operates one or more sales channels, comprising:
determining, by a processor, a customer's willingness to wait in purchasing, based on at least purchasing history of a customer;
formulating, by the processor, a purchase probability model that predicts a likelihood of the customer performing a purchase now compared to waiting to make the purchase, the purchase probability model formulated based on at least the customer's willingness to wait in purchasing;
solving a personalized price menu optimization model with one or more rules as constraints that jointly determines multiple prices, based on at least the purchase probability model, a price corresponding to a different purchase option with different lead time; and
generating the personalized deal menu based on at least the solving.

2. The method of claim 1, wherein the personalized price menu specifies a product, and the multiple prices associated with the product and lead times respectively associated with the multiple prices.

3. The method of claim 2, wherein the multiple prices comprise prices for different sales channels.

4. The method of claim 1, further comprising generating the personalized price menu optimization model as one or more of a bi-level nested attraction model and a bi-level attraction model.

5. The method of claim 1, further comprising generating the personalized price menu optimization model as a single item maximization problem.

6. The method of claim 1, further comprising generating the personalized price menu optimization model as a multi-product problem.

7. The method of claim 1, wherein the personalized deal menu is generated responsive to the customer inputting a product, and is sent to the customer over one or more of a mobile device and a web site page.

8. A computer readable storage medium storing a program of instructions executable by a machine to perform a method of computing a personalized deal menu for a seller that operates one or more sales channels, the method comprising:
determining, by a processor, a customer's willingness to wait in purchasing, based on at least purchasing history of a customer;
formulating, by the processor, a purchase probability model that predicts a likelihood of the customer performing a purchase now compared to waiting to make the purchase, the purchase probability model formulated based on at least the customer's willingness to wait in purchasing;
solving a personalized price menu optimization model with one or more rules as constraints that jointly determines multiple prices, based on at least the purchase probability model, a price corresponding to a different purchase option with different lead time; and
generating the personalized deal menu based on at least the solving.

9. The computer readable storage medium of claim 8, wherein the personalized price menu specifies a product, and the multiple prices associated with the product and lead times respectively associated with the multiple prices.

10. The computer readable storage medium of claim 9, wherein the multiple prices comprise prices for different sales channels.

11. The computer readable storage medium of claim 8, further comprising generating the personalized price menu optimization model as one or more of a bi-level nested attraction model and a bi-level attraction model.

12. The computer readable storage medium of claim 8, further comprising generating the personalized price menu optimization model as a single item maximization problem.

13. The computer readable storage medium of claim 8, further comprising generating the personalized price menu optimization model as a multi-product problem.

14. The computer readable storage medium of claim 8, wherein the personalized deal menu is generated responsive to the customer inputting a product, and is sent to the customer over one or more of a mobile device and a web site page.

15. A system for computing a personalized deal menu for a seller that operates one or more sales channels, the method comprising:
one or more storage devices operable to store customer profile comprising purchasing history of a customer, product data and price data;
a hardware processor operable to determine a customer's willingness to wait in purchasing, based on at least the purchasing history of a customer,
the hardware processor further operable to formulate a purchase probability model that predicts a likelihood of the customer performing a purchase now compared to waiting to make the purchase, the purchase probability model formulated based on at least the customer's willingness to wait in purchasing,
the hardware processor further operable to solve a personalized price menu optimization model with one or more rules as constraints that jointly determines multiple prices, based on at least the purchase probability model, a price corresponding to a different purchase option with different lead time,
the hardware processor further operable to generate the personalized deal menu based on at least the solving.

16. The system of claim 15, wherein the personalized price menu specifies a product, and the multiple prices associated with the product and lead times respectively associated with the multiple prices.

17. The system of claim 16, wherein the multiple prices comprise prices for different sales channels.

18. The system of claim 15, further comprising generating the personalized price menu optimization model as one or more of a bi-level nested attraction model and a bi-level attraction model.

19. The system of claim 15, further comprising generating the personalized price menu optimization model as a single item maximization problem.

20. The system of claim 15, further comprising generating the personalized price menu optimization model as a multi-product problem.
